(19) United States
(12) Patent Application Publication
(10) Pub. No.: US 2006/0257313 A1
(43) Pub. Date: Nov. 16, 2006

(54) Hydrolysis of chemical hydrides utilizing hydrated compounds

(76) Inventors: Alan Cisar, Cypress, TX (US); Carlos Salinas, Bryan, TX (US); Sandra Withers-Kirby, College Station, TX (US); Brad Fiebig, Bryan, TX (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(21) Appl. No.: 11/357,352

(22) Filed: Feb. 16, 2006

Related U.S. Application Data
(60) Provisional application No. 60/653,707, filed on Feb. 17, 2005.

(51) Int. Cl. C09K 3/00; C01B 3/02; B01J 19/00

(52) U.S. Cl. 423/648.1; 252/183.14; 422/198

(57) ABSTRACT

A method for dissipating heat in a hydrogen generator, comprising the steps of (a) providing a first chamber containing a first material selected from the group consisting of hydrates, (b) providing a second chamber containing a second material selected from the group consisting of hydrides and borohydrides, (c) causing the first material to undergo an endothermic reaction to evolve water, and (d) transporting a portion of the evolved water from the first chamber into the second chamber such that the second material undergoes an exothermic reaction to evolve hydrogen gas.

### CROSS-REFERENCE TO RELATED APPLICATION

This application claims priority to U.S. provisional patent application No. 60/653,707, filed 17 Feb. 2005, and having the same title.

### STATEMENT OF GOVERNMENT RIGHTS

This invention was made with government support under contract W15P7T-04-C-P415 awarded by the Department of Defense (Army). The government has certain rights in this invention.

### FIELD OF THE DISCLOSURE

The present disclosure relates generally to methods of hydrolysis of chemical hydrides, and more specifically to methods of hydrolysis of chemical hydrides that utilize water-generating compounds for hydrolysis rather than simply water.

### BACKGROUND OF THE DISCLOSURE

Hydrogen generators are devices that generate hydrogen gas for use in fuel cells, combustion engines, and other devices, frequently through the evolution of hydrogen gas from hydrides or borohydrides and other hydrogen-generating materials. Sodium borohydride (NaBH₄) has emerged as a particularly desirable material for use in such devices, due to the molar equivalents of hydrogen it generates (see EQUATION 1 below), the relatively low mass of NaBH₄ as compared to some competing materials, and the controllability of the hydrogen evolution reaction:
NaBH₄+2H₂O NaBO₂+4H₂ (EQUATION 1)
Other materials, such as lithium aluminum hydride and related alanes, are also of interest.

The hydrolysis of hydrogen-generating materials in general, and sodium borohydride in particular, as a method of hydrogen generation has received significant interest, due to the high gravimetric storage density of hydrogen in these materials and the ease of creating a pure hydrogen stream from the hydrolysis reaction. However, for some applications, the exothermic nature of the hydrolysis reaction is a drawback from a system perspective, especially when thermal management is an issue. For example, when hydrogen generators are to be used to power consumer electronic devices such as laptop computers, it is critical that the generator does not contribute significantly to the operating temperature of the device. Unfortunately, many hydrogen-generating materials exhibit significant heat spikes in the hydrolysis reaction, especially in the early stages. Even when it is possible to eliminate such spikes, the amount of heat generated by the hydrolysis reaction itself is often considerable.

There is thus a need in the art for a means for effectively dissipating the heat generated by a hydrogen generator. There is further a need in the art for such a heat dissipation means that can be used with small or compact consumer devices such as laptops and cell phones. These and other needs are met by the devices and methodologies disclosed herein and hereinafter described.

### SUMMARY OF THE DISCLOSURE

It has now been found that the above noted needs can be met by the devices and methodologies disclosed herein.

In one aspect, a method for dissipating heat in a hydrogen generator is provided. In accordance with the method, a first material is provided which is selected from the group consisting of hydrides, borohydrides and alanes, and a second material is provided which is selected from the group consisting of hydrates. The first material is caused to undergo an exothermic reaction to evolve hydrogen gas, and the second material is caused to undergo an endothermic reaction to evolve water. The ratio of the first material to the second material is chosen to maintain the hydrogen generator within a predefined temperature range.

In another aspect, a method for dissipating heat in a hydrogen generator is provided. In accordance with the method, a first chamber is provided which contains a first material selected from the group consisting of hydrates, and a second chamber is provided which contains a second material selected from the group consisting of hydrides, borohydrides and alanes. The first material is caused to undergo an endothermic reaction to evolve water, and at least a portion of the water so evolved is transported from the first chamber into the second chamber such that the second material undergoes an exothermic reaction to evolve hydrogen gas.

In still another aspect, a hydrogen generator is provided which comprises (a) a reaction chamber; (b) a first material disposed in the reaction chamber and selected from the group consisting of hydrides, borohydrides and alanes; and (c) a second material disposed in the reaction chamber and selected from the group consisting of hydrates. The amount of the first material in the reaction chamber is m₁, and the amount of the second material in the reaction chamber is m₂. The first material undergoes an exothermic reaction to generate hydrogen that is characterized by a maximum enthalpy of reaction of H₁, and the second material undergoes an endothermic reaction to evolve water that is characterized by a maximum enthalpy of reaction of H₂. In many embodiments, the ratio m₁H₁/m₂H₂ is less than about 1.

In yet another aspect, a method for dissipating heat in a hydrogen generator is provided. In accordance with the method, a first material is provided which is selected from the group consisting of hydrides, borohydrides and alanes, and a second material is provided which is selected from the group consisting of hydrates. The first material is caused to undergo an exothermic reaction to evolve hydrogen gas, and the second material is caused to undergo an endothermic reaction to evolve water. The ratio of the first material to the second material is chosen to maintain the hydrogen generator within a predefined temperature range.

In still another aspect, a fuel cell for a hydrogen generator is provided. The fuel cell comprises a porous substrate, a first layer having a mean thickness t₁ and comprising a first material selected from the group consisting of hydrides and borohydrides, and a second layer having a mean thickness t₂ and comprising a second material selected from the group consisting of hydrates.

In yet another aspect, a composition is provided which comprises a hydrogen generating material, such as, for example, a hydride, borohydride, or alane, and an alkaline material which is disposed over the surfaces of said hydrogen generating material.

In a further aspect, a composition is provided which comprises a hydrogen generating material, and a delayed release composition disposed over the surfaces of said hydrogen generating material.

These and other aspects of the present disclosure are described in greater detail below with respect to the systems, methodologies, and compositions described herein.

### BRIEF DESCRIPTION OF THE DRAWINGS

For a more complete understanding of the systems, methodologies, and compositions described herein and the advantages thereof, reference is now made to the following description taken in conjunction with the accompanying drawings in which like reference numerals indicate like features and wherein:

FIG. 1 is an illustration of a first embodiment of a hydrogen generator made in accordance with the teachings herein;

FIG. 2 is an illustration of a second embodiment of a hydrogen generator made in accordance with the teachings herein;

FIG. 3 is an illustration of a third embodiment of a hydrogen generator made in accordance with the teachings herein; and

FIG. 4 is an illustration of a fourth embodiment of a hydrogen generator made in accordance with the teachings herein.

### DETAILED DESCRIPTION

It has now been found that the aforementioned needs can be met through the provision of a hydrogen generator in which the exothermic hydrogen evolution reaction is counterbalanced by a parallel endothermic reaction, such as a dehydration reaction, so that the net heat generated by the hydrogen generator, or the rate at which heat is generated, is reduced, eliminated, or kept within a desired range. In some embodiments, the parallel endothermic reaction may contribute the water needed for the hydrogen evolution reaction and, in some cases, the catalyst required for that reaction as well.

In some embodiments, the materials for the parallel endothermic reaction may be intimately mixed with the materials for the hydrogen evolution reaction and may be chemically reacted to generate the water required for the hydrogen evolution reaction. In such embodiments, the amount of water required to complete the hydrogen generation reaction may be reduced to amounts that approach the theoretical minimum. Hence, the weight penalty associated with these systems is minimized.

The devices and methodologies disclosed herein may be further understood with reference to the following non-limiting embodiments. It will be appreciated that a number of variations exist with respect to each of these embodiments, and that the descriptions of these embodiments are intended to be illustrative, but not limiting.

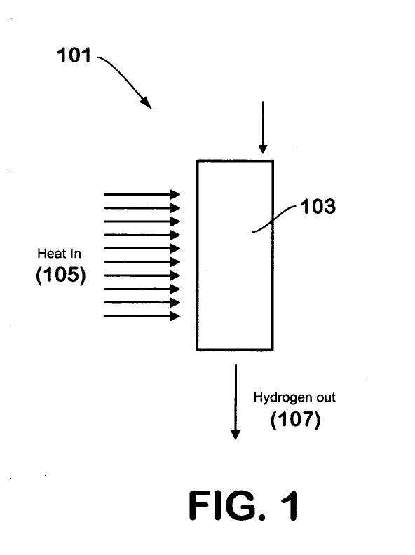

FIG. 1 illustrates a first embodiment of a hydrogen generator 101 made in accordance with the teachings herein. In this embodiment, a suitable hydrogen-generating compound 103, such as, for example, a hydride, borohydride, borane, alane, or aminoborane, is combined with a salt hydrate or other water-generating material and a catalyst (if needed). The mixture may be in a powder form, or may be in the form of granules or pellets. For example, a pneumatic press may be utilized to generate pellets of a desired size or shape from a powder mixture of the hydrogen-generating compound and the water-generating material.

To begin the reaction, thermal energy 105 is supplied to the mixture in a localized region to initiate the dehydration reaction that generates water from the water-generating material. Once generated, the water is available for the hydrolysis reaction that evolves hydrogen gas, and the hydrogen gas so evolved exits the reaction chamber through a hydrogen gas outlet 107. If the hydrolysis reaction is more exothermic than the dehydration reaction is endothermic (taking into account the relative amounts of reactants participating in each reaction), then the reaction will sustain itself to completion. If, on the other hand, the hydrolysis reaction utilizing the water of dehydration is less exothermic than the dehydration reaction is endothermic (again taking into account the relative amounts of reactants participating in each reaction), the reaction will not be sustained without additional energy input. This feature can be used advantageously to control the net heat generated by the system during the hydrolysis reaction and/or the rate at which heat is evolved.

It will be appreciated from the foregoing that the relative amounts of reactants for the two parallel reactions is an important consideration, since it directly affects the net energy generated by the system that is released as heat. Hence, the relative molar amounts of these components may be selected to keep the total amount of heat generated within a desired range. The specific amounts of these materials will typically be selected taking into consideration the environment that the hydrogen generator will be operating in, and how much heat capacity that environment has without exceeding desired temperature extremes.

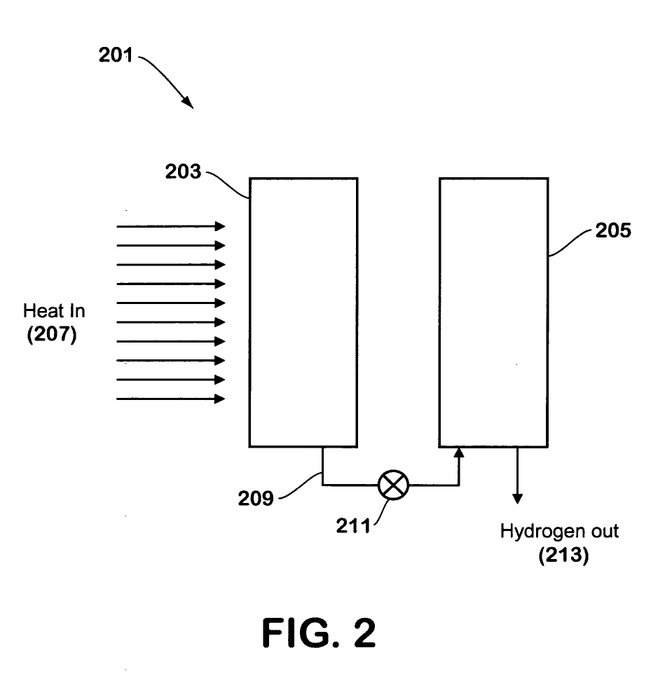

FIG. 2 illustrates a second embodiment of a hydrogen generator made in accordance with the teachings herein. In this embodiment, the hydrogen generator 201 comprises first 203 and second 205 distinct chambers. The first chamber 203 contains a material that is capable of undergoing a dehydration reaction to yield water, preferably with the application of heat 207. Such a material may be, for example, a hydrated salt selected from the group consisting of acetates, bromides, chlorides, formides, fluorides, iodides, phosphates, and thiosulfates, and is preferably a sulfate of aluminum, beryllium, calcium, iron, magnesium, potassium, or sodium. The hydrated compound releases water at specific temperatures, absorbing thermal energy in the process.

The hydrogen generator is further provided with a conduit 209 which conducts water released by the hydrated compound from the first chamber 203 into the second chamber 205. The conduit may be equipped with a suitable valve 211 or other control means which controls the amount of water introduced into the second chamber 205. The valve may be electrically controlled to release water into the second chamber 205 based on hydrogen demand or on other parameters. As the released water contacts the hydrogen-generating compound, the ensuing hydrolysis reaction produces hydrogen gas, which exits the second chamber 205 by way of a hydrogen gas outlet 213. As with the hydrogen generator of the first embodiment, the relative ratios of the materials in the first 203 and second 205 chambers may be varied to achieve a system that operates within a desired temperature range.

In some variations of the hydrogen generator 201 depicted in FIG. 2, the second chamber 205 is charged with a mixture of a suitable hydrogen-generating material, a salt hydrate, and a catalyst (if needed). These materials may be in various forms. For example, they may be in a powder form or may be pressed into granules or pellets. The first chamber 203 contains an aqueous solution. When hydrogen is needed, the aqueous solution is introduced from the first chamber 203 into the second chamber 205 via conduit 209. The salt hydrate absorbs the thermal energy generated by the hydrolysis reaction, releasing further amounts of water for continued hydrolysis. If the hydrolysis reaction, utilizing the water of dehydration, is more exothermic than the dehydration is endothermic (taking into account the relative amounts of reactants participating in each reaction), the reaction will sustain itself to completion. If, on the other hand, the hydrolysis reaction is less exothermic than the dehydration is endothermic (again taking into account the relative amounts of reactants participating in each reaction), the reaction will not be sustained without additional energy input. In the later case, appropriate energy input into the system can be made when a hydrogen demand is present. The amount of energy input required can be made small (in relation to the energy generated by consumption of the evolved hydrogen gas) through appropriate selection of the reactants and the relative amounts of these materials, and/or through the use of suitable catalysts.

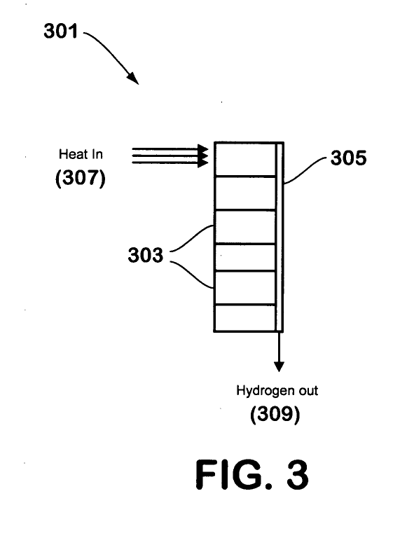

FIG. 3 illustrates a further embodiment of a hydrogen generator made in accordance with the teachings herein. The hydrogen generator 301 illustrated contains a plurality of segregated compartments 303 which are in communication with a common manifold 305. Each of the compartments 303 contains a mixture of a hydrogen-generating compound and a salt hydrate or other water generating material. In some embodiments, each compartment is thermally insulated from the adjacent compartments. Heat 307 may be applied to each compartment separately from the remaining compartments. In some embodiments, as in those embodiments where the total amount of energy liberated by the hydrolysis reaction is less than the amount of energy consumed by the dehydration reaction, one or more heating elements may be provided within each compartment 303. These heating elements may be, for example, resistive wires interspersed amongst the hydrogen-generating material.

The hydrogen generator 301 of FIG. 3 is particularly suitable for use with hydrogen-generating materials whose hydrogen evolution reaction is difficult to control. By thermally isolating each compartment from adjacent compartments, if a run-away reaction occurs, it can be contained to an individual compartment, so that the maximum heat spike associated with the event is controllable within a desired range.

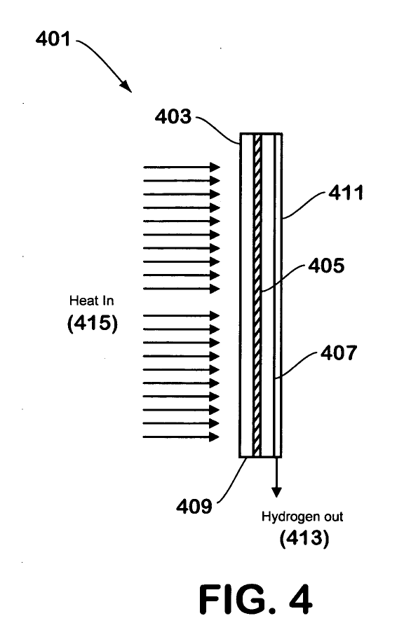

FIG. 4 illustrates another embodiment of a hydrogen generator made in accordance with the teachings herein. The hydrogen generator 401 depicted therein comprises a housing 403 having a porous medium 405 therein. A hydrogen-generating material 407 is disposed on a first side of the porous medium 405, and a salt hydrate 409 or other water-generating material is disposed on the opposing side of the porous medium 405. The device is equipped with a manifold 411 disposed on the side of the device adjacent to the hydrogen-generating material and on the same side of the porous medium 405 as the hydrogen-generating material. The manifold is equipped with a suitable hydrogen outlet 413 to permit the egress of hydrogen gas out of the device.

In use, as heat is applied to the hydrogen generator, it is absorbed by the salt hydrate 409 or other water-generating material, which in turn undergoes a dehydration reaction to generate water. The water permeates the porous separator, where it reacts with the hydrogen-generating composition to generate hydrogen gas. It will be appreciated that, while the hydrogen generator 401 is depicted as being a substantially planar device, it may assume a variety of shapes, both planar and non-planar, and it may also contain multiple layers. For example, the device may be wound around a central axis, with each winding containing the individual layers depicted in FIG. 4.

1. Water-Generating Materials

Various materials can be used as the water-generating materials in the various devices and methodologies described herein. Typically, these materials are salt hydrates that are capable of undergoing a dehydration reaction to yield water, preferably with the application of heat. Such a hydrate may be, for example, a hydrated salt selected from the group consisting of acetates, bromides, chlorides, formides, fluorides, iodides, phosphates, and thiosulfates, and is preferably a sulfate of aluminum, beryllium, calcium, iron, magnesium, potassium, or sodium. The hydrated compound releases water at specific temperatures, absorbing thermal energy in the process. Specific examples of some of these materials, and their respective physical properties, are set forth in TABLES 1-3.

TABLE 1
Water Generating Capacity of Salt Hydrates

| | | | | Weight of |
|---|---|---|---|---|
| | | | Volume of material | material to |
| | | Moles of | to hold 150 cc of | hold 150 cc |
| | | water | usable water | of usable water |
| Compound | Formula | available | (mL) | (grams) |
| Aluminum ammonium sulfate | AlNH₄(SO₄)₂*12H₂O | 12 | 191 | 315 |
| Aluminum fluoride | AlF₃*3H₂O | 3 | 133 | 383 |
| Aluminum potassium sulfate | AlK(SO₄)₂*12H₂O | 12 | 188 | 329 |
| Aluminum sulfate | Al2(SO₄)₃*18H₂O | 18 | 192 | 309 |
| Cobalt acetate | Co(OOCCH₃)₂*4H₂O | 4 | 303 | 519 |
| Cobalt chloride | CoCl₂*6H₂O | 6 | 172 | 330 |
| Cobalt(II) sulfate | CoSO₄*7H₂O | 7 | 165 | 335 |
| Iron(II) sulfate | FeSO₄*7H₂O | 7 | 174 | 331 |
| Magnesium sulfate | MgSO₄*7H₂O | 7 | 175 | 293 |
| Nickel(II) sulfate | NiSO₄*6H₂O | 6 | 176 | 365 |
| Sodium metaborate | Na₂B₂O4*8H₂O | 8 | 144 | 287 |
| Sodium phosphate | NaPO₄*12H₂O | 12 | 165 | 264 |
| Sodium sulfate | Na₂SO₄*10H₂O | 10 | 184 | 269 |
| Sodium thiosulfate | Na₂S₂O₃*5H₂O | 5 | 245 | 414 |
| Copper sulfate | CuSO₄*5H₂O | 5 | 182 | 416 |
| Copper nitrate | Cu(NO₃)₂*6H₂O | 6 | 198 | 410 |

TABLE 2
Weight and Density of Salt Hydrates

| | Molecular Weight | | | |
|---|---|---|---|---|
| Compound | (g/mol) | Mol. Weight anhydrous | % water | Specific Gravity |
| Aluminum ammonium sulfate | 453.33 | 237.14 | 0.48 | 1.65 |
| Aluminum Fluoride | 138.02 | 83.98 | 0.39 | 2.882 |
| Aluminum potassium sulfate | 474.38 | 258.2 | 0.46 | 1.75 |
| Aluminum sulphate | 666.42 | 342.15 | 0.49 | 1.61 |
| Cobalt Acetate | 249.07 | 177.01 | 0.29 | 1.71 |
| Cobalt chloride | 237.93 | 129.84 | 0.45 | 1.924 |
| Cobalt(II) sulphate | 281.1 | 154.99 | 0.45 | 2.03 |
| Iron(II) sulphate | 278.02 | 151.91 | 0.45 | 1.897 |
| Magnesium sulphate | 246.48 | 120.37 | 0.51 | 1.68 |
| Nickel(II) sulphate | 262.86 | 154.77 | 0.41 | 2.07 |
| Sodium metaborate | 275.72 | 131.6 | 0.52 | 2 |
| Sodium phosphate | 380.12 | 163.94 | 0.57 | 1.6 |
| Sodium sulfate | 322.2 | 142.04 | 0.56 | 1.46 |
| Sodium thiosulfate | 248.18 | 158.11 | 0.36 | 1.69 |
| Copper sulfate | 249.68 | 159.60 | 0.36 | 2.284 |
| Copper nitrate | 295.65 | 187.56 | 0.37 | 2.074 |

TABLE 3
Melting/Dehydration Temperatures of Salt Hydrates

| | Melting | Dehydration | Enthalpy of | |
|---|---|---|---|---|
| | Point | Temp | dehydration | Cost/ |
| Compound | (° C.) | (° C.) | (kcal/mol) | gram |
| Aluminum ammonium | 94.5 | 250 | −858.06 | 0.055 |
| sulfate | | | | |
| Aluminum Fluoride | | | | 0.095 |
| Aluminum potassium | 92 | | | |
| sulfate | | | | |
| Aluminum sulphate | | | −1299.72 | |
| Cobalt Acetate | 140 | 140 | | 0.065 |
| Cobalt chloride | 54 | 130 | −430.9 | 0.103 |
| Cobalt(II) sulphate | 41.5 | 71 | −499.92 | 0.13 |
| Iron(II) sulphate | 64 | 64 | −378.07 | 0.065 |
| Magnesium sulphate | | 150 | −502.82 | 0.031 |
| Nickel(II) sulphate | 100 | 100 | −432.58 | 0.027 |
| Sodium metaborate | 53.5 | | | 0.01 |
| Sodium phosphate | 75 | | | 0.041 |
| Sodium sulfate | | | | |
| Sodium thiosulfate | 100 | 100 | | 0.019 |
| Copper sulfate | 110 | 150 | | |
| Copper nitrate | 26.4 | 26.4¹ | | |

¹For 3H₂0

While the use of salt hydrates as the water-generating material is preferred (due in part to the large amounts of thermal energy per unit weight that can be consumed by the dehydration reaction these materials), materials other than hydrate salts may be used in place of, or in addition to, these materials in the various devices and methodologies disclosed herein. For example, materials that undergo condensation reactions (especially dehydration condensation reactions), either by themselves or by reacting with other materials, may be used. One example of such a material includes materials that undergo condensation polymerization reactions. Another example of such a material are materials that undergo dehydration reactions, either through intramolecular or intermolecular processes. For example, carboxylic acids and polycarboxylic acids that undergo dehydration reactions to form the corresponding ester, ether, or acetate, either through an intermolecular reaction or through an intramolecular reaction, may be utilized in some embodiments as the water-generating material. A further advantage of this type of material is that the dehydration product may contain no hydration states, or fewer hydration states, than the starting material, thus increasing the total amount of water liberated by the reaction.

A further class of materials that may be used in this capacity include sterically hindered hydrates that exhibit rotational isomerism. These materials are capable of undergoing rotation about the axis of a central bond (this will frequently be a boron carbon bond, a nitrogen-nitrogen bond, or a carbon-carbon bond, but may occur around other bonds as well) to transition between at least a first and second isomeric state. The material is provided in a first state in which it is an n-hydrate material at temperature T₁. However, upon exposure to heat, it undergoes a dehydration reaction, and also undergoes rotation about the bond to transition to a second isomeric state in which it is a k-hydrate material at T₁, wherein n>k. This may be, for example, because of a change in symmetry of the second state compared to the first state, or because of the presence of hydrogen bonding or other phenomenon which interfere with the ability of water molecules to bind to the material (hydrogen bonding and other such phenomenon may also be utilized advantageously to keep the material in the second isomeric state after rotation about the axis has occurred). As a result of this reaction, the hydrate loses water irreversibly or semi-irreversibly.

A similar phenomenon may be used with the hydrogen-generating material itself. That is, the hydrogen-generating material may be designed so that, when it undergoes the hydrogen evolution reaction, the heat evolved causes the resulting byproduct to assume (preferably irreversibly) a second rotational isomeric state in which it binds to a reduced amount of water, as compared to the rotational isomers of the byproduct. The heat adsorbed by the change in isomeric states may serve as a further aid in controlling the overall heat generated by the hydrogen generator. In some embodiments, rotational isomers may be used as a heat adsorbing means, even without respect to their possible hydration states.

In some embodiments of the devices, methodologies and compositions described herein, steric hindrance can be utilized as a mechanism to prevent the hydrogen-generating material from undergoing a hydration reaction, as, for example, by occluding binding sites for water molecules in the reaction byproduct. In these embodiments, various substituted hydrides, borohydrides, boranes, aminoboranes, hydrazines, and the like may be utilized as the sterically hindered reactant, with the choice of substituents depending in part on the stereochemistry of the system. These materials offer the potential advantage of consuming most, if not all, of the water present in the system in the hydrogen-generation reaction, whether that water is present as free water molecules or water of crystallization.

Still another class of materials useful as a source of stored moisture are polymer hydrates. These compounds include (but are not limited to) polycarboxylic acids, polyacrylamides, and other polymeric materials with functional groups capable of binding to water. Both classes of compounds can act to solidify, or gel, large quantities of water. Unlike inorganic hydrates, these materials lack both a crystalline structure (i.e., they are amorphous) and a sharp melting or dehydration temperature. Both give up their water over a broad temperature range. The use of compounds such as these in a reactor of the type described above can produce a gradual release of water. In some embodiments, the rate of release may increase with any increase in temperature.

Some of these compounds, notably polyacrylimides, have another useful feature, namely, that their affinity for water tends to vary inversely with the ionic strength of the solution they are in contact with. This means that a saturated polymer in contact with a dilute ionic solution will release water into the solution as its ion concentration increases. If a solid hydride is brought into contact with a polymer saturated with respect to pure water, the increase in ionic concentration in the solution brought about by the hydrolysis reaction will cause the polymer to release additional water.

2. Housing Geometries

The housings utilized in the hydrogen generators described herein may have various shapes. Preferably, these housings are cylindrical, due to the ability of such a geometry to readily accommodate the pressures that the casing may be subjected to as hydrogen gas is evolved and accumulates within the interior of the casing. However, it will be appreciated that various other geometries may also be utilized. For example, the outer casing may be spherical, rectangular, cubical, rhombohedral, ellipsoidal, or the like.

3. Housing Materials

Various materials may be used in the housings of the hydrogen generators described herein. Preferably, the housing comprises aluminum, due to the unique combination of strength, light weight, and relative chemical inertness. However, it will be appreciated that the housing could also be constructed from various other materials, including various metals (such as magnesium, tin, titanium, and their alloys) and various metal alloys, including steel. The housing may also comprise various polymeric materials, including polyethylene, polypropylene, PVC, nylon, graphite, and various glasses. If the housing comprises a metal such as aluminum, the interior of the housing is preferably coated with a protective layer of a suitable material, such as an epoxy resin, which is inert to the reactants and the products and byproducts of the hydrolysis reaction. The housing, or portions thereof, may also be thermally insulated.

4. Hydrogen-Generating Materials

Various materials may be used as the hydrogen-generating materials in the devices and methodologies described herein. Hydrides, or combinations of hydrides, that produce hydrogen upon contacting water at temperatures that are desired within the hydrogen generator may be used in the devices and methodologies described herein. Salt-like and covalent hydrides of light metals, especially those metals found in Groups I and II, and even some metals found in Group III, of the Periodic Table are useful and include, for example, hydrides of lithium, sodium, potassium, rubidium, cesium, magnesium, beryllium, calcium, aluminum or combinations thereof. Preferred hydrides include, for example, borohydrides, alanates, or combinations thereof.

As shown in TABLE 4 and TABLE 5 below, the hydrides of many of the light metals appearing in the first, second and third groups of the periodic table contain a significant amount of hydrogen on a weight percent basis and release their hydrogen by a hydrolysis reaction upon the addition of water. The hydrolysis reactions that proceed to an oxide and hydrogen (see TABLE 5) provide the highest hydrogen yield, but may not be useful for generating hydrogen in a lightweight hydrogen generator that operates at ambient conditions because these reactions tend to proceed only at high temperatures. Therefore, the most useful reactions for a lightweight hydrogen generator that operates at ambient conditions are those reactions that proceed to hydrogen and a hydroxide. Both the salt-like hydrides and the covalent hydrides are useful compounds for hydrogen production because both proceed to yield the hydroxide and hydrogen.

TABLE 4
Hydrogen Content of Metal Hydrides

| | Wt % H₂ | | |
|---|---|---|---|
| | | With Stoichiometric | Double Stoichiometric |
| Compound | Neat | H₂O | H₂O |
| Salt-like Hydrides | | | |
| LiH | 12.68 | 11.89 | 7.76 |
| NaH | 4.20 | 6.11 | 4.80 |
| KH | 2.51 | 4.10 | 3.47 |
| RbH | 1.17 | 2.11 | 1.93 |
| CsH | 0.75 | 1.41 | 1.33 |
| MgH₂ | 7.66 | 9.09 | 6.47 |
| CaH₂ | 4.79 | 6.71 | 5.16 |
| Covalent Hydrides | | | |
| LiBH₄ | 18.51 | 13.95 | 8.59 |
| NaBH₄ | 10.66 | 10.92 | 7.34 |
| KBH₄ | 7.47 | 8.96 | 6.40 |
| Mg(BH₄)₂ | 11.94 | 12.79 | 8.14 |
| Ca(BH₄)₂ | 11.56 | 11.37 | 7.54 |
| LiAlH₄ | 10.62 | 10.90 | 7.33 |
| NaAlH₄ | 7.47 | 8.96 | 6.40 |
| KAlH₄ | 5.75 | 7.60 | 5.67 |
| Li₃AlH₆ | 11.23 | 11.21 | 7.47 |
| Na₃AlH₆ | 5.93 | 7.75 | 5.76 |

TABLE 5
Hydrogen Yield from the Hydrolysis of Metal Hydrides

| | | Hydrogen Yield | |
|---|---|---|---|
| | | (wt %) | |
| | Equation | Stoichiometric | Double |
| Reaction | No. | Water | Water |
| Reaction to Oxide | | | |
| LiBH₄ + 2H₂O → LiBO₂ + 4H₂ | 1 | 13.95 | 8.59 |
| 2LiH + H₂O → Li₂O + 2H₂ | 2 | 11.89 | 7.76 |
| NaBH₄ + 2H₂O → NaBO₂ + 4H₂ | 3 | 10.92 | 7.34 |
| LiAlH₄ + 2H₂O → LiAlO₂ + 4H₂ | 4 | 10.90 | 7.33 |
| Reaction to Hydroxide | | | |
| LiBH₄ + 4H₂O → LiB(OH)₄ + 4H₂ | 5 | 8.59 | 4.86 |
| LiH + H₂O → LiOH + H₂ | 6 | 7.76 | 4.58 |
| NaBH₄ + 4H₂O → NaB(OH)₄ + 4H₂ | 7 | 7.34 | 4.43 |
| LiAlH₄ + 4H₂O → LiAl(OH)₄ + 4H₂ | 8 | 7.33 | 4.43 |
| Reaction to Hydrate Complex | | | |
| LiH + 2H₂O → LiOH.H₂O + H₂ | 9 | 4.58 | 2.52 |
| 2LiAlH₄ + 10H₂O → LiAl₂(OH)₇.H₂O + LiOH.H₂O + 8H₂ | 10 | 6.30 | 3.70 |
| NaBH₄ + 6H₂O → NaBO₂.4H₂O + 4H₂ | 11 | 5.49 | 3.15 |

The salt-like hydrides, such as LiH, NaH, and MgH₂, are generally not soluble in most common solvents under near ambient conditions. Many of these compounds are only stable as solids, and decompose when heated, rather than melting congruently. These compounds tend to react spontaneously with water to produce hydrogen, and continue to react as long as there is contact between the water and the salt-like hydride. In some cases the reaction products may form a blocking layer that slows or stops the reaction, but breaking up or dispersing the blocking layer or removing it from the reaction zone immediately returns the reaction to its initial rate as the water can again contact the unreacted hydride. Methods for controlling the hydrogen production from the salt-like compounds generally include controlling the rate of water addition.

The covalent hydrides shown in TABLE 4 are comprised of a covalently bonded hydride anion, e.g., BH₄⁻, AlH₄⁻, and a simple cation, e.g., Na⁺, Li⁺. These compounds are frequently soluble in high dielectric solvents, although some decomposition may occur. For example, NaBH₄ promptly reacts with water at neutral or acidic pH but the reaction is kinetically quite slow at alkaline pH. When NaBH₄ is added to neutral pH water, the reaction proceeds but, because the product is alkaline, the reaction slows to a near stop as the pH of the water rises and a metastable solution is formed. In fact, a basic solution of NaBH₄ is stable for months at temperatures below 5° C.

Some of the covalent hydrides, such as LiAlH₄, react very similarly to the salt-like hydrides and react with water in a hydrolysis reaction as long as water remains in contact with the hydrides. Others covalent hydrides react similarly to NaBH₄ and KBH₄ and only react with water to a limited extent, forming metastable solutions. However, in the presence of catalysts, these metastable solutions continue to react and generate hydrogen.

Using a catalyst to drive the hydration reaction of the covalent hydrides to completion by forming hydrates and hydrogen is advantageous because the weight percent of hydrogen available in the covalent hydrates is generally higher than that available in the salt-like hydrides, as shown in TABLE 4. Therefore, the covalent hydrides are preferred as a hydrogen source in some embodiments of a hydrogen generator because of their higher hydrogen content as a weight percent of the total mass of the generator.

The devices and methodologies described herein may use solid chemical hydrides as the hydrogen-generating material which is combined with water in a manner that facilitates a hydrolysis reaction to generate hydrogen gas. Preferably, these chemical hydrides include alkali metal borohydrides, alkali metal hydrides, metal borohydrides, and metal hydrides, including, but not limited to, sodium borohydride NaBH₄ (sometimes designated NBH), sodium hydride (NaH), lithium borohydride (LiBH₄), lithium hydride (LiH), calcium hydride (CaH₂), calcium borohydride (Ca(BH₄)₂), magnesium borohydride (MgBH₄), potassium borohydride (KBH₄), and aluminum borohydride (Al(BH₄)₃).

Another class of materials that may be useful in the devices and methodologies described herein are chemical hydrides with empirical formula BₓNₓH_{y} and various compounds of the general formula BₓN_{y}H_{z}. Specific examples of these materials include aminoboranes such as ammoniaborane (H₃BNH₃), diborane diammoniate, H₂B(NH₃)₂BH₄, poly-(aminoborane), borazine (B₃N₃H₆), morpholine borane, borane-tetrahydrofuran complex, diborane, and the like. In some applications, hydrazine and its derivatives may also be useful, especially in applications where the toxicity of many hydrazine compounds is trumped by other considerations.

Various hydrogen gas-generating formulations may be prepared using these or other aminoboranes (or their derivatives). In some cases, the aminoboranes may be mixed and ball milled together with a reactive heat-generating compound, such as LiAlH₄, or with a mixture, such as NaBH₄ and Fe₂O₃. Upon ignition, the heat-generating compound in the mixture undergoes an exothermic reaction, and the energy released by this reaction pyrolyzes the aminoborane(s), thus forming boron nitride (BN) and H₂ gas. A heating wire, comprising nichrome or other suitable materials, may be used to initiate a self-sustaining reaction within these compositions.

5. Catalysts

As noted above, in some instances, a catalyst may be required to initiate the hydrolysis reaction of the chemical hydride with water. Useful catalysts for this purpose include one of more of the transition metals found in Groups IB-VIII of the Periodic Table. The catalyst may comprise one or more of the precious metals and/or may include cobalt, nickel, tungsten carbide or combinations thereof. Ruthenium, ruthenium chloride and combinations thereof are preferred catalysts.

Various organic pigments may also be useful in catalyzing the hydrolysis reaction. Some non-limiting examples of these materials include pyranthrenedione, indanthrene Gold Orange, ditridecyl-3,4,9,10-perylenetetracarboxylic diimide, indanthrene black, dimethoxy violanthrone, quinacridone, 1,4-di-keto-pyrrolo (3,4 C) pyrrole, indanthrene yellow, copper phthalocyanine, 3,4,9,10, perylenetetracarboxylic dianhydride, isoviolanthrone, perylenetetracarboxylic diimide, and perylene diimide. These materials, most of which are not metal based, may offer environmental or cost advantages in certain applications.

The catalysts used in the devices and methodologies disclosed herein may be present as powders, blacks, salts of the active metal, oxides, mixed oxides, organometallic compounds, or combinations of the foregoing. For those catalysts that are active metals, oxides, mixed oxides or combinations thereof, the hydrogen generator may further comprise a support for supporting the catalyst on a surface thereof.

The catalyst can be incorporated into the hydrolysis reaction in a variety of ways, including, but not limited to: (i) mixing the catalyst with the hydrogen-generating material first, and then adding water to the hydrogen-generating material/catalyst mixture; (ii) mixing the catalyst with the reactant water first, and then adding this solution/mixture to the hydrogen-generating material; or (iii) combining the hydrogen-generating material with water in the presence of a porous structure that is made of, or contains, a catalyst. The hydrogen generating devices described herein can be adapted to support one or more of these methods for incorporating catalyst into a reactor.

Catalyst concentrations in the hydrogen-generating compositions described herein may vary widely. For some applications, the set catalyst concentration may range between about 0.1 wt % to about 20 wt % active metals based on the total amount of hydride and on the active element or elements in the catalyst. Preferably, the set catalyst concentration may range from between about 0.1 wt % to about 15 wt %, and more preferably, between about 0.3 wt % to about 7 wt %.

6. Antifoaming Agents

In some embodiments of the devices and methodologies disclosed herein, an antifoaming agent is added to the water that is introduced into the reaction chamber. The use of an antifoaming agent may be advantageous in some applications or embodiments, since the generation of hydrogen during the hydration reaction frequently causes foaming. Hence, by adding an antifoaming agent to the reactant water, the size and weight of the hydrogen generator can be minimized, since less volume is required for disengagement of the gas from the liquid/solids. Polyglycol anti-foaming agents offer efficient distribution in aqueous systems and are tolerant of the alkaline pH conditions found in hydrolyzing borohydride solutions. Other antifoam agents may include surfactants, glycols, polyols and other agents known to those having ordinary skill in the art.

7. pH Adjusting Agents

Various pH adjusting agents may be used in the devices and methodologies disclosed herein. The use of these agents may be advantageous in some embodiments in that the hydration reaction typically proceeds at a faster rate at lower pHs. Hence, the addition of a suitable acid to the reaction chamber, as by premixing the acid into reactant water, may accelerate the evolution of hydrogen gas. Indeed, in some cases, the use of a suitable acid eliminates the need for a catalyst. Some non-limiting examples of acids that may be suitable for this purpose include, for example, mineral acids, carboxylic acids, sulfonic acids and phosphoric acids.

In some embodiments, carboxylic acids and the like may be used as the pH adjusting agent. These materials may be advantageous in certain applications because they frequently exist in various hydration states, and hence provide additional water to the system. Moreover, some carboxylic acids are capable of undergoing condensation reactions, with the addition of heat, to evolve water. Hence, these materials can aid both with thermal control and by contributing water to the system.

While it may be desirable in some applications of the systems and methodologies disclosed herein to utilize a pH adjusting agent to lower the pH of a hydrogen-generating composition or of a liquid medium that is to be reacted with it, in other applications, the use of a pH adjusting agent may be utilized to increase the pH of the hydrogen-generating composition or the liquid medium with which it reacts. For example, while many hydrogen-generating compositions achieve a higher rate of hydrogen evolution at lower pHs, and while this is desirable in some situations, in other situations, as when it is necessary to transport the hydrogen-generating composition, a high rate of hydrogen evolution may be disadvantageous. In these situations, a pH adjusting agent may be utilized to render the composition more alkaline upon exposure of the material to water or moisture, hence making the composition less reactive and safer to handle.

Some non-limiting examples of alkaline pH adjusting agents include, without limitation, various metal hydroxides, including lithium hydroxide, sodium hydroxide, potassium hydroxide, RbOH, CsOH, ammonium hydroxide, N(CH₃)₄OH, NR₄OH, NR^{a}ₓR^{b}₍₄₋ₓ₎OH, and NR^{a}R^{b}R^{c}R^{d}OH compounds, wherein R^{a}, R^{b}, R^{c} and R^{d} can each independently be hydrogen, alkyl, or aryl groups; various metal oxides, such as Li₂O, Na₂O, K₂O, Rb₂O, Cs₂O; various organic and metal amines; and the like.

8. Delayed Release Compositions

Various delayed-release compositions may be utilized in the hydrogen-generating materials described herein. Such materials, which may be utilized, for example, to control the reactivity of the hydrogen-generating materials, include, without limitation, slow-release coatings, micro-encapsulations, and/or slowly-dissolving polymer carriers. For example, in some applications, it may be desirable to render the hydrogen-generating composition initially unreactive to water or moisture so that the composition will be safer for handling and transportation. In one particular type of embodiment, this may be accomplished by providing the composition in the form of pellets, granules, or other discrete units whose surfaces are coated with one or more layers of a material or materials that prevent, delay or control the reaction of the composition with moisture, water, or one or more liquid reactants.

One particular example of a delayed release composition that may be used with the hydrogen generating compositions described herein is ethyl cellulose. This material is an excellent film-forming material with strong adhesion that is insoluble in water and that can be used to create a moisture-impermeable barrier over the surfaces of a hydrogen-generating material. It may be used in conjunction with plasticizers such as phthalates, phosphates, glycerides, and esters of higher fatty acids and amides to create films of sufficient flexibility. Ethyl cellulose may be used alone or in combination with water soluble materials such as methyl cellulose as a barrier to delay the reaction of hydrogen-generating materials with water or with other liquid reactions or solutions. Ethyl cellulose coatings may be applied by spray coating or from solutions of appropriate solvents such as cyclohexane.

In some embodiments, ethyl cellulose based films or other suitable materials may be used to form a protective film over hydrogen-generating materials that render these materials safer for shipping and handling. At the point of use, the coated hydrogen-generating material may then be reacted with water or with other liquid reactants or solutions in a controlled or time delayed manner.

In some embodiments, this reaction may be facilitated through the addition of suitable amounts of appropriate solvents and/or surfactants to the liquid reactants or solutions that facilitate the removal of the coating. In the case of ethyl cellulose, for example, if the hydrogen-generating material is being reacted with water or an aqueous solution, suitable amounts of such solvents as ethanol, methanol, acetone, chloroform, ethyl lactate, methyl salicylate, toluene, methylene chloride, or various mixtures of the foregoing may be added to the water or aqueous solution to facilitate the removal of, or the generation of openings in, the coating, thereby allowing the hydrogen-generating material to react. The concentration of these solvents may be manipulated to achieve a desired rate of reaction or to permit the onset of the reaction in a desired time frame.

Alternatively or in combination with the foregoing approach, the coating may be formulated with a sufficient amount of a water soluble material such as methyl cellulose to permit the hydrogen-generating material to react at a desire to rate, or in a desired timeframe, upon exposure to water or to the aqueous solution. It will be appreciated that wide variations of release rates or release patterns can be achieved by varying polymer ratios and coating weights.

In other embodiments, a protective coating or coatings may be applied to pellets, granules, or particles of a hydrogen-generating material to render the material safer for handling and transportation. At the point of use, this coating or coatings may then be stripped with a suitable solvent prior to use of the hydrogen-generating material. Since the total amount of coating applied to the hydrogen-generating material may be quite small, and since the complete removal of this coating from the surfaces of the hydrogen-generating material may not be necessary to render the material suitably reactive to water or to other reagents, in many instances the amount of solvent required to render the material suitably reactive may be quite small.

In still other embodiments, coating removal may be achieved at the point of use through mechanical or physical means. For example, the coated particles of the hydrogen generating material may be subjected to mechanical stress so as to rupture the coating, thereby exposing a portion of the underlying hydrogen-generating material for reaction (in such embodiments, the coating may be made sufficiently brittle so that it is frangible). This can be achieved, for example, by grinding or abrading the particles, subjecting the particles to pressure or sound waves, heating the particles (e.g., so as to induce thermal stress in the coating or to melt or soften the coating), irradiating the particles, or the like.

In some embodiments, the hydrogen-generating composition may be mixed with water-generating materials of the type described herein, and the aforementioned mechanical or physical means may be utilized to induce the evolution of water from the water-generating material. The resulting evolution of hydrogen gas may then rupture or cause perforations or disruptions in the coating, thereby exposing a portion of the hydrogen-generating material for further reaction.

In one specific embodiment, a container of the hydrogen-containing material may be provided which is equipped with a pull tab. When the tab is pulled, the associated mechanical action causes the coating on a portion of the particles to be stripped or ruptured, thereby rendering this portion of the particles available for immediate reaction with water or another suitable liquid medium. The remaining particles can be engineered with a timed release profile that is suitable for the particular application.

In other embodiments, the hydrogen-generating composition may be provided with, or interspersed with, conductive filaments or another suitably conductive medium that can generate localized heating of the particles through ohmic resistance. At the point of use, a suitable electric current can be passed through the conductive medium to melt or rupture a portion of the coating on some of the particles. In such embodiments, the coating may comprise a material such as a hydrocarbon wax that has a suitably low melting or softening temperature.

In further embodiments, multiple coatings schemes or compositions may be utilized to produce a plurality of species of coated hydrogen-generating materials that have different reaction rates, or that react in different timeframes, with respect to a given liquid reagent. For example, in one possible embodiment, a plurality of particles species M₁, . . . , Mₙ, wherein n≧2, may be created that have respective coatings C₁, . . . , Cₙ, wherein, for i=1 to n, coating Cᵢ allows a percentage pᵢ of the hydrogen generating material in particle species Mᵢ to react with water or another liquid reagent within tᵢ minutes. The species M₁, . . . , Mₙ may then be mixed in various relative proportions, concentrations or weight percentages such that the resulting mixture has a desired hydrogen generation profile as a function of time.

As noted above, in some embodiments, multiple coatings may be utilized that have different chemical or physical properties. For example, in some embodiments, a modified release coating may be used as an external coating, and a stabilizing coating may be used as an interior coating. In such embodiments, the stabilising coat may act as a physical barrier between the hydrogen-generating material and the modified release coating.

For example, the stabilising coat may act to slow migration of moisture or solvent between the modified release coating and the hydrogen-generating material. While the stabilising coat will preferably keep the hydrogen-generating separated from the modified release coating during storage, the stabilising coating will preferably not interfere significantly with the rate of release or reaction of the hydrogen-generating material and therefore may be semi-permeable or even soluble in water or in the liquid medium that the hydrogen-generating material is to be reacted with. Hence, the stabilizing coat may be utilized to keep migration of hydrogen-generating materials to a minimum such that their interaction with coating materials is reduced or prevented, while still allowing for release of hydrogen-generating materials in an aqueous environment.

The stabilizing coat may be any suitable material which creates an inert barrier between the hydrogen-generating material and the modified release coating, and may be water soluble, water swellable or water permeable polymeric or monomeric materials. Examples of such materials include, but are not limited to, hydroxypropylmethyl cellulose, hydroxypropyl cellulose, polyvinyl pyrrolidone, polyethylene glycol or methacrylate based polymers. Preferably the stabilising coat includes a water-soluble polymer that does not interfere with the release of the hydrogen-generating material.

The modified release coating may also be any suitable coating material, or combination of coating materials, that will provide the desired modified release profile. For example, coatings such as enteric coatings, semi-enteric coatings, delayed release coatings or pulsed release coatings may be desired. In particular, coatings may be utilized that provide an appropriate lag in release prior to the rapid release at a rate essentially equivalent to immediate release of the hydrogen-containing material.

In particular, materials such as hydroxypropylmethyl cellulose phthalate of varying grades, methacrylate based polymers and hydroxypropylmethyl cellulose acetate succinate may be utilized in various applications. It is also possible to use a mixture of enteric polymers to produce the modified release coating, or to use a mixture of enteric polymer with a water permeable, water swellable or water-soluble material. Suitable water-soluble or water permeable materials include but are not limited to hydroxypropylmethyl cellulose, hydroxypropyl cellulose, polyvinyl pyrrolidone, polyethylene glycol or mixtures thereof.

Another class of delayed release coatings that may be utilized in some embodiments of the compositions, systems and methodologies described herein are basic materials, such as metal hydroxides or metal or organic amines, including the materials described herein as pH adjusting agents. In the case of hydrogen-generating materials that react with water or aqueous solutions, coatings of these materials on the exterior surfaces of the hydrogen-generating materials can be used to render the hydrogen-generating material essentially unreactive (or reactive at a very slow rate) to moisture or to relatively small amounts of water by rendering the effective pH at the reaction interface (e.g., at the surface of the hydrogen-generating material) sufficiently alkaline. On the other hand, if the amount of coating material is sufficiently small, at the point of use, the amount of water or liquid medium that the hydrogen-generating material is exposed to may be sufficiently large to solvate the alkaline material without significantly affecting the pH of the resulting solution. So long as the coating is selected such that solvation occurs fast enough, the presence of such a coating can be made to have little or no effect on the reactivity of the particles of the hydrogen-generating material at the point of use.

9. Wicking Agents

The hydration reaction of many hydrogen-generating materials cannot proceed if water is unable to reach the hydride. When pellets of some hydrogen-generating materials, such as LiH or NaBH₄, react with water, a layer of insoluble reaction products is formed that blocks further contact of the water with the hydride. The blockage can slow down or stop the reaction. In some cases, the addition of a wicking agent within the pellets or granules of the hydrogen-generating material improves the water distribution through the pellet or granule and ensures that the hydration reaction quickly proceeds to completion. Both salt-like hydrides and covalent hydrides can benefit from an effective dispersion of water throughout the hydride. Useful wicking materials include, for example, cellulose fibers like paper and cotton, modified polyester materials having a surface treatment to enhance water transport along the surface without absorption into the fiber, and polyacrylamide, the active component of disposable diapers. The wicking agents may be added to the hydrogen-generating material in any effective amount, preferably in amounts between about 0.5 wt % and about 15 wt % and most preferably, between about 1 wt % and about 2 wt %. It should be noted, however, that, in some applications, variations in the quantity of wicking material added to the hydrogen-generating material do not seem to be significant; i.e., a small amount of wicking material is essentially as effective as a large amount of wicking material.

10. Liquid Reactants

While the devices and methodologies described herein have frequently been explained in reference to the use of water as a reactant with the hydride, borohydride, borane, or other hydrogen-generating material, it will be appreciated that various other materials may be used in place of, or in addition to, water. For example, various alcohols may be reacted with the hydrogen-generating material. Of these, low molecular weight alcohols, such as methanol, ethanol, normal and iso-propanol, normal, iso- and secondary-butanol, ethylene glycol, propylene glycol, butylene glycol, and mixtures thereof, are especially preferred. The alcohols may be used either alone or as aqueous solutions of varying concentrations. Liquid reactants containing alcohol may be particularly useful in low temperature applications where the liquid reactant may be subjected to freezing. Various liquid reactants containing ammonia or other hydrogen containing materials may also be used.

11. Porous Member

Various materials may be used in the porous members of the hydrogen generators described herein (see, e.g., element 405 in FIG. 4). In some embodiments, these members may contain multiple components. For example, the member may contain a first layer of a porous material, such as screening or plastic or wire mesh or foam, and a second layer of a porous wicking agent. In other embodiments, these elements may be combined (for example, a suitable wicking agent may be deposited on the surfaces of a wire or plastic mesh or foam, or the mesh itself may have wicking characteristics). Specific, non-limiting examples of foams that may be used in the reaction interface include aluminum, nickel, copper, titanium, silver, stainless steel, and carbon foams. The surface of the foam may be treated to increase a hydrophilic nature of the surface. Cellular concrete may also be used in the reaction interface.

A method of effecting hydrolysis is provided, along with a fuel cell system employing the same. The method utilizes a parallel endothermic reaction that also contributes the water needed for hydrolysis, and in some cases the catalyst required for the hydrolysis reactions.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1. A method for dissipating heat in a hydrogen generator, comprising:
providing a first material selected from the group consisting of hydrides, borohydrides and alanes;
providing a second material selected from the group consisting of hydrates;
causing the first material to undergo an exothermic reaction to evolve hydrogen gas; and
causing the second material to undergo an endothermic reaction to evolve water;
wherein the ratio of the first material to the second material is chosen to maintain the hydrogen generator within a predefined temperature range.

2. The method of claim 1, wherein the ratio of the first material to the second material is chosen to maintain the hydrogen generator within an ergonomically acceptable temperature range.

3. The method of claim 1, wherein the second material is a polymeric material.

4. The method of claim 3, wherein the polymeric material is a polycarboxylic acid.

5. The method of claim 3, wherein the polymeric material is a polyacrylamide.

6. The method of claim 3, wherein the polymeric material has multiple hydration states.

7. The method of claim 1, wherein the second material is mixed with the first material.

8. The method of claim 1, wherein the first material is a hydride.

9. The method of claim 1, wherein the first material is a metal hydride.

10. The method of claim 1, wherein the first material is a borohydrate.

11. The method of claim 1, wherein the first material is an alane.

12. The method of claim 1, wherein the first material further comprises a material selected from the group consisting of pyranthrenedione, indanthrene Gold Orange, ditridecyl-3,4,9,10-perylenetetracarboxylic diimide, indanthrene black, dimethoxy violanthrone, quinacridone, 1,4-di-keto-pyrrolo (3,4 C) pyrrole, indanthrene yellow, copper phthalocyanine, 3,4,9,10, perylenetetracarboxylic dianhydride, isoviolanthrone, perylenetetracarboxylic diimide, and perylene diimide.

13. A method for dissipating heat in a hydrogen generator, comprising:
providing a first chamber containing a first material selected from the group consisting of hydrates;
providing a second chamber containing a second material selected from the group consisting of hydrides, borohydrides and alanes;
causing the first material to undergo an endothermic reaction to evolve water; and
transporting a portion of the evolved water from the first chamber into the second chamber such that the second material undergoes an exothermic reaction to evolve hydrogen gas.

14. The method of claim 13, wherein the ratio of the first material to the second material is chosen to maintain the hydrogen generator within an ergonomically acceptable temperature range.

15. The method of claim 13, wherein the second material is a polymeric material.

16. The method of claim 15, wherein the polymeric material is a polycarboxylic acid.

17. The method of claim 15, wherein the polymeric material is a polyacrylamide.

18. The method of claim 15, wherein the polymeric material has multiple hydration states.

19. The method of claim 13, wherein the second material is mixed with the first material.

20. The method of claim 13, wherein the first material is a hydride.

21. The method of claim 13, wherein the first material is a metal hydride.

22. The method of claim 13, wherein the first material is a borohydrate.

23. The method of claim 13, wherein the first material is an alane.

24. the method of claim 13, wherein the first material further comprises a material selected from the group consisting of pyranthrenedione, indanthrene Gold Orange, ditridecyl-3,4,9,10-perylenetetracarboxylic diimide, indanthrene black, dimethoxy violanthrone, quinacridone, 1,4-di-keto-pyrrolo (3,4 C) pyrrole, indanthrene yellow, copper phthalocyanine, 3,4,9,10, perylenetetracarboxylic dianhydride, isoviolanthrone, perylenetetracarboxylic diimide, and perylene diimide.

25. The method of claim 1, wherein the second material is
selected from the group consisting of hydrates which are not hydration products of the first material.

26. The method of claim 25, wherein the hydrated salt does not comprise a hydrated borate or a hydrated metaborate.

27. A hydrogen generator, comprising:
a reaction chamber;
a first material disposed in the reaction chamber and selected from the group consisting of hydrides, borohydrides and alanes;
a second material disposed in the reaction chamber and selected from the group consisting of hydrates;
wherein the amount of the first material in the reaction chamber is m₁, wherein the amount of the second material in the reaction chamber is m₂, wherein the first material undergoes an exothermic reaction to generate hydrogen that is characterized by a maximum enthalpy of reaction of H₁, wherein the second material undergoes an endothermic reaction to evolve water that is characterized by a maximum enthalpy of reaction of H₂, and wherein the ratio m₁H₁/m₂H₂ is less than about 2.

28. A fuel cell for a hydrogen generator, comprising:
a porous substrate;
a first layer having a mean thickness t₁ and comprising a first material selected from the group consisting of hydrides and borohydrides; and
a second layer having a mean thickness t₂ and comprising a second material selected from the group consisting of hydrates.

29. The fuel cell of claim 28, wherein the thicknesses t₁ and t₂ are chosen to maintain the maximum operating temperature of the fuel cell below a predetermined limit.

30. A method for dissipating heat in a hydrogen generator, comprising:
providing a first material selected from the group consisting of hydrides and borohydrides;
providing a second material selected from the group consisting of hydrates;
causing the first material to undergo an exothermic reaction to evolve hydrogen gas; and
causing the second material to undergo an endothermic reaction to evolve water;
wherein the ratio of the first material to the second material is chosen to maintain the hydrogen generator within a predefined temperature range.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)
